(19) United States
(12) Patent Application Publication
(10) Pub. No.: US 2016/0166110 A1
(43) Pub. Date: Jun. 16, 2016

(54) Toaster With Horizontal Translating Grill Wires

(71) Applicant: HAMILTON BEACH BRANDS, INC., Glen Allen, VA (US)

(72) Inventors: John D. Barnes, Richmond, VA (US); Melvin M.A. Zhang, Wong Chuk Hang (CN)

(21) Appl. No.: 14/565,530

(22) Filed: Dec. 10, 2014

(51) Int. Cl. A47J 37/08; A23L 1/01

(52) U.S. Cl. CPC A47J 37/0814; A23L 1/01; A23V 2002/00

(57) ABSTRACT

A toaster comprises a housing having at least one food item receiving slot defined in a top surface, at least one spring-loaded food item support, first and second opposing end plates within the housing, first and second opposing grill wire assemblies positioned between and generally perpendicular to the first and second end plate, a lifter bracket selectively movable between an up position and a down position, and first and second pivoting guide rods. Each guide rod cooperates with a first guide arm of a corresponding grill wire assembly such that each guide rod restrains inward movement of a corresponding one of the first and second grill wire assemblies when each guide rod is in a first position and such that each guide rod does not restrain inward movement of a corresponding one of the first and second grill wire assemblies when each guide rod is in a second position.

### FIELD OF THE INVENTION

The present invention relates generally to kitchen appliances and more particularly to toasters.

### BACKGROUND OF THE DISCLOSURE

Pop-up toasters are well known. Conventional pop-up toasters generally have a housing with at least one food item receiving slot defined within the housing. Corresponding to and aligned with each of the food item receiving slots is a spring-loaded food item support contained within the housing. Each food item support holds a bread, pasty product, or other similar food product (e.g., frozen waffle) while one or more heating elements (also within the housing) apply heat to the bread product, thereby toasting the bread product. Toasters are capable of toasting many different types of food items; the term “bread products” is used generically herein to refer to all of the different types of food items that may be toasted by a toaster. The food item support is movable between an up position and a down position by way of a lifter knob. The lifter knob is external to the housing and affixed to the food support by way of a lifter arm and lifter bracket. Thus, the lifter knob, lifter arm, lifter bracket, and food item support tray selectively move up and down in unison.

The food item support is biased toward its up position. In the up position, a bread product may be inserted onto the food item support. When in the down position, an electrical circuit is completed which starts a toast cycle and applies power to the heating elements to toast the bread product.

The food item support moves up and down between two opposing grill wire assemblies. The bottoms of the grill wire assemblies are typically affixed at pivot points and the tops of the grill wire assemblies selectively move inward and outward such that the grill wire assemblies selectively pivot. The tops of the grill wire assemblies are biased outward by way of biasing springs. When the lifter bracket moves down, the lifter bracket pulls the biasing springs, which causes the grill wire assemblies to pivot inward. The inward pivoting of the grill wire assemblies causes the grill wire assemblies to grab and hold the bread product during toasting. However, because of the pivoting movement of the grill wire assemblies, the bread product is held only at or near the top portion of the bread product and the bottom portion of the bread product is not held. Thus, movement of the top portion of the bread product is restricted but movement of the bottom portion of the bread product is not restricted. As a result, the application of heat to the bread product during the toasting cycle can cause the bottom portion of the bread product to curl. Such curling is undesirable because the toasted bread product will not sit flat upon a plate when removed from the toaster. Moreover, the unsupported portion of the bread product may be closer/farther from a heating element than the supported portion of the bread product. The unequal distance between the two portions of the bread product can lead to uneven toasting, which is undesirable from the user's perspective.

It is desired that there be a new mechanism that is capable of toasting a bread product while holding the entire bread product such that movement of the entire bread product is restricted and curling is prevented. The toaster of the following disclosure accomplishes the above and other objectives and overcomes at least the above-described disadvantages of conventional toaster and methods of toasting.

### BRIEF SUMMARY OF THE DISCLOSURE

A kitchen appliance for toasting bread products and the like is disclosed herein. In one embodiment of the subject appliance, the toaster comprises a housing having at least one food item receiving slot defined in a top surface and at least one spring-loaded food item support that is selectively movable between an up position and a down position and is biased toward the up position. The at least one food item support would be aligned with the at least one food item receiving slot. First and second opposing end plates are provided within the housing. At least the first end plate having first and second horizontal opposing slots defined therein. Further, first and second opposing grill wire assemblies are positioned between and generally perpendicular to the first and second end plates. The grill wire assemblies would be parallel to each other. The first and second opposing grill wire assemblies comprise a first guide arm projecting through a corresponding one of the first and second horizontal slots in the first end plate. One or more springs are included for biasing the first and second opposing grill wire assemblies toward each other. A lifter bracket is selectively movable between an up position and a down position to thereby selectively move the food item support between its up position and its down position. First and second pivoting guide rods cooperate with the first guide arm of a corresponding grill wire assembly such that each guide rod restrains inward movement of a corresponding one of the first and second grill wire assemblies when each guide rod is in a first position and such that each guide rod does not restrain inward movement of a corresponding one of the first and second grill wire assemblies when each guide rod is in a second position.

A toaster as disclosed herein may further provide that the guide rods in a second position are pivoted inwardly (toward each other) relative to the first position of each guide rod. Each guide rod can further cooperate with the lifter bracket such that the lifter bracket restrains inward pivoting movement of the guide rods when the lifter bracket is in its up position and such that the lifter bracket does not restrain inward pivoting movement of the guide rods when the lifter bracket is in its down position. Each of the first and second pivoting guide rods may comprise an outwardly arcuate lower portion.

In addition to the toaster, as described above, other embodiments of the invention are directed to a method for toasting a food item. Such a method comprises a step of receiving a food item through a food item receiving slot defined in a top surface of a housing of a toaster and onto a spring-loaded food item support that is selectively movable between an up position and a down position and biased toward the up position; the food item support being aligned with the food item receiving slot. The method further comprises a step of lowering, in response to user action, a lifter bracket that is selectively movable between an up position and a down position to its down position, thereby moving the food item support to its down position. There is further a step of allowing, in response to the lowering of the lifter bracket to its down position, first and second pivoting guide rods to inwardly pivot from a first position to a second position. An addition step of allowing, in response to the first and second pivoting guide rods inwardly pivoting from the first position to the second position, first and second opposing grill wire assemblies to move inwardly toward each other is also provided. The first and second opposing grill wire assemblies being positioned within the housing between and generally perpendicular to first and second end plates. Each of the first and second opposing grill wire assemblies comprising a first guide arm projecting through a corresponding one of first and second opposing horizontal slots in the first end plate, each of the first and second pivoting guide rods cooperating with the first guide arm of a corresponding grill wire assembly such that each guide rod restrains inward movement of a corresponding one of the first and second grill wire assemblies when each of the first and second pivoting guide rods is in its first position and such that each of the first and second pivoting guide rods does not restrain inward movement of a corresponding one of the first and second grill wire assemblies when each of the first and second pivoting guide rods is in its second position.

In one embodiment of the method disclosed herein, each of the first and second pivoting guide rods further cooperates with the lifter bracket or a lifter guide such that the lifter bracket or lifter guide restrains inward pivoting movement of the first and second pivoting guide rods when the lifter bracket is in its up position and such that the lifter bracket does not restrain inward pivoting movement of the first and second pivoting guide rods when the lifter bracket is in its down position. The method may further comprise first and second pivoting guide rods that comprise an outwardly arcuate lower portion. The method may also comprise allowing, in response to the lowering of the lifter bracket to its down position, third and fourth pivoting guide rods to inwardly pivot from a first position to a second position. Each of the first and second opposing grill wire assemblies would further comprise a second guide arm projecting through a corresponding one of first and second opposing horizontal slots in the second end plate. Each of the third and fourth pivoting guide rods would cooperate with the second guide arm of a corresponding grill wire assembly such that each of the third and fourth pivoting guide rods also restrains inward movement of a corresponding one of the first and second grill wire assemblies when each of the third and fourth pivoting guide rods is in its first position and such that each of the third and fourth pivoting guide rods does not restrain inward movement of a corresponding one of the first and second grill wire assemblies when each of the third and fourth pivoting guide rods is in its second position.

### BRIEF DESCRIPTION OF THE SEVERAL VIEWS OF THE DRAWING(S)

Having thus described the invention in general terms, reference will now be made to the accompanying drawings, which are not necessarily drawn to scale. The foregoing summary, as well as the following detailed description of the disclosure, will be better understood when read in conjunction with the appended drawings. It should be understood, however, that the disclosure is not limited to the precise arrangements and instrumentalities shown, wherein:

FIG. 1 is an isometric view of a toaster, in accordance with embodiments of the present invention.

FIG. 2 is an isometric view of a portion of the toaster of FIG. 1, with the housing removed.

FIG. 3 is an isometric view of a food item support removed from the toaster of FIG. 1.

FIG. 4 is an isometric view of grill wire assemblies removed from the toaster of FIG. 1.

FIG. 5 is an isometric view of a pivoting guide rods removed from the toaster of FIG.

FIG. 6 is a front view of a portion of the toaster of FIG. 1, with the housing removed and the lifter bracket in its up position.

FIG. 7 is a front view of a portion of the toaster of FIG. 1, with the housing removed and the lifter bracket in its down position.

FIG. 8 is a rear view of a portion of the toaster of FIG. 1, with the housing removed.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “leftward,” “rightward,” “inward,” “outward,” “up,” “upward,” “down,” and “downward” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the appliance disclosed herein provide a toaster that enables a user to toast a bread product that is fully supported within the toaster during the toasting cycle to minimize or prevent undesirable curling of the bread product.

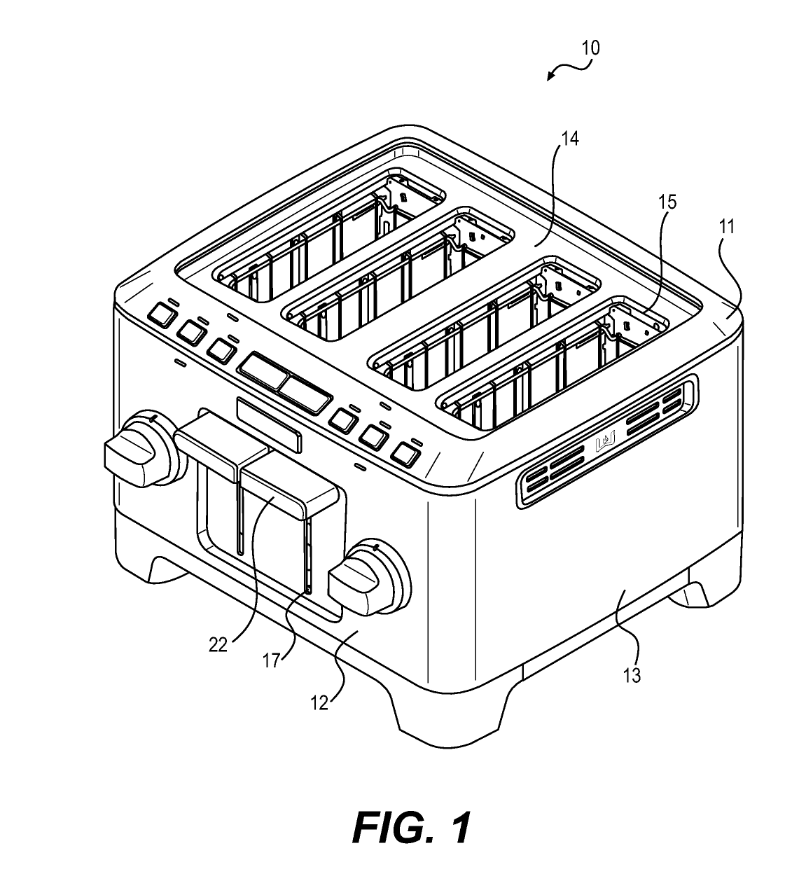

Referring now to FIGS. 1-8 wherein like numerals indicate like elements throughout, there is illustrated a toaster 10 in accordance with an embodiment of the present disclosure. As illustrated in FIG. 1, toaster 10 comprises a housing 11 which may have a generally cuboid shape as shown. The housing 11 comprises a front surface 12 and opposing rear surface (not illustrated), opposing side surfaces 13 (only one side surface is illustrated), a top surface 14, and a bottom surface (not illustrated). Four food item receiving slots 15 are defined in the top surface 14 of the housing 11 (pop-up toasters generally, but not necessarily, have two or four such slots). The toaster 10 will typically comprise a variety of user input and output elements (illustrated but not labeled), such as a darkness control and a power light.

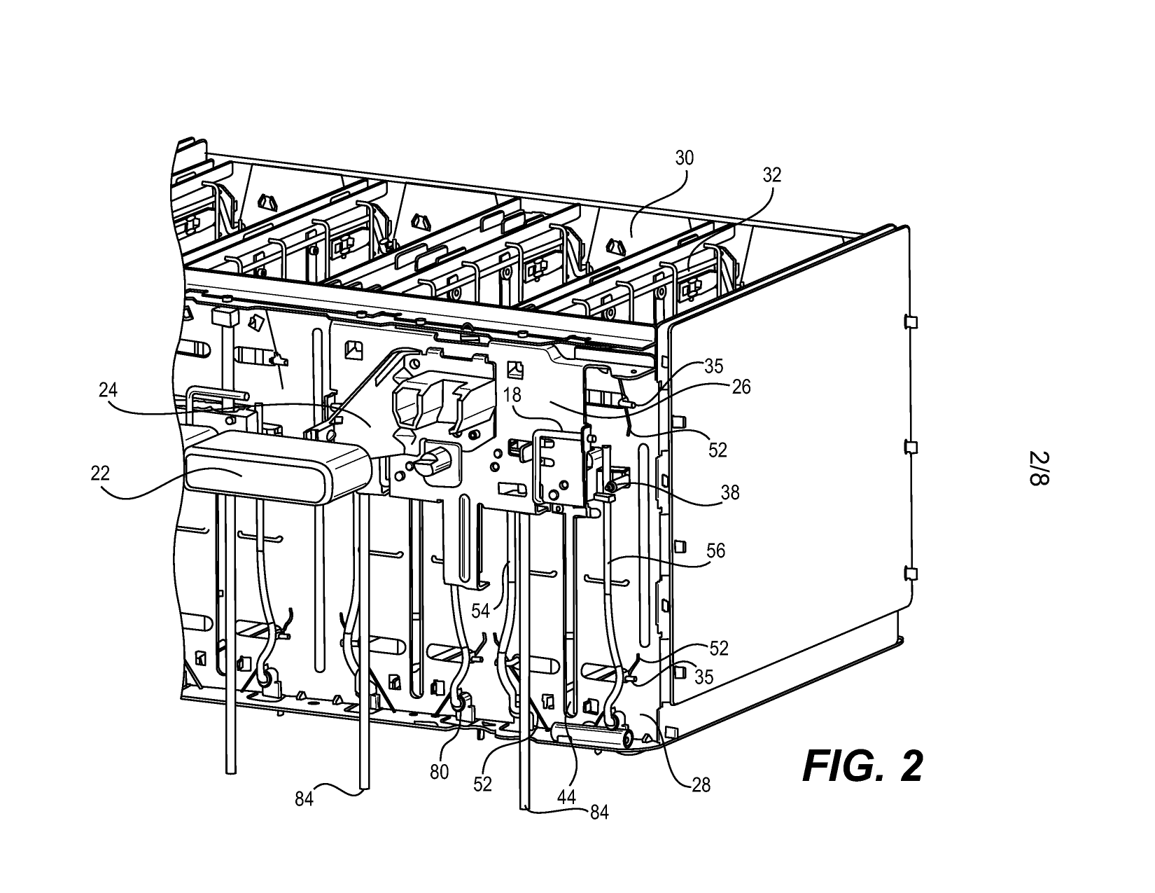

Lifter knobs 22 are external to the housing 11. Each lifter knob 22 corresponds to two food item receiving slots 15. When a user placed a bread product in one or more of the food item receiving slots the user pushes down the corresponding lifter knob 22 to retract the bread product into the toaster and begin the toasting cycle. Each lifter knob 22 is connected to a corresponding lifter arm 24 (seen in FIGS. 2, 6 and 7). Toaster 10 has a substantially vertical lifter arm slot 17 defined in the front surface 12. The lifter arm slot 17 comprises an elongated opening that is wide enough to enable the lifter arm 24 to move up and down within the slot and is generally narrow enough to reduce the likelihood of foreign objects being inserted through the lifter arm slot. The toaster 10 will typically comprise one or more heating elements (not illustrated) for selectively applying heat to a bread product during a toasting operation

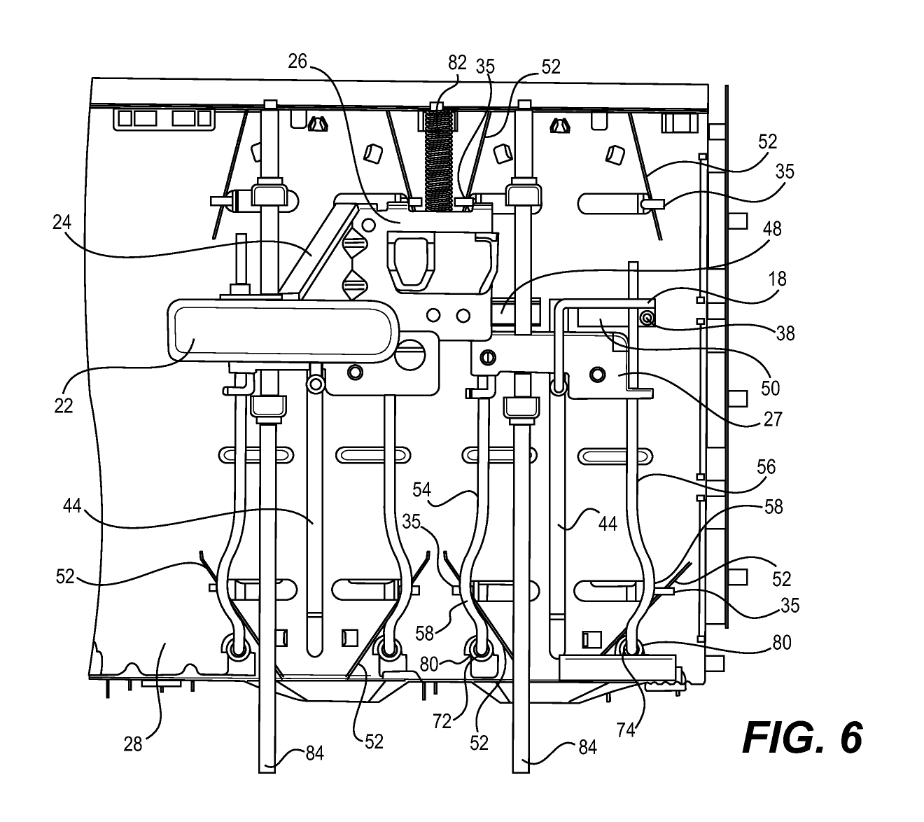

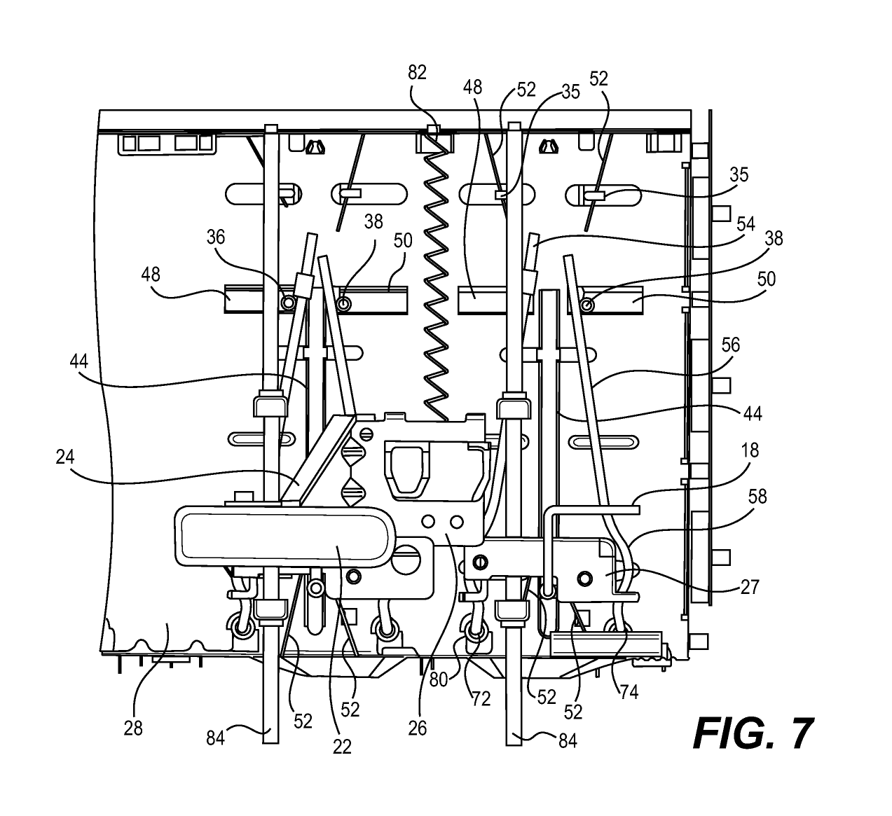

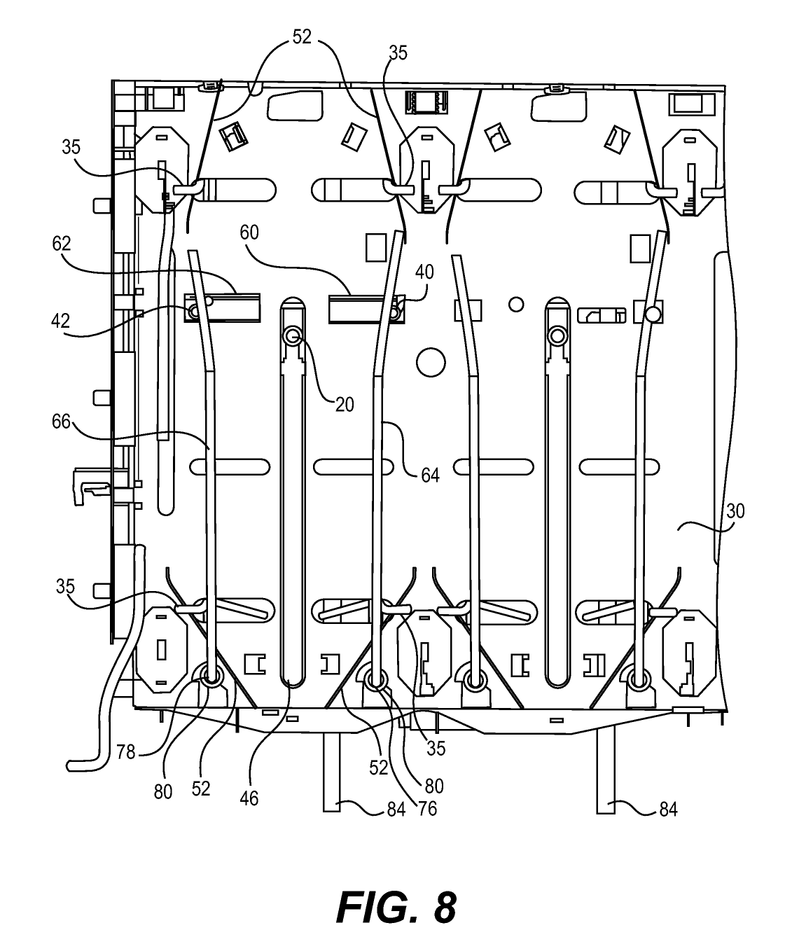

Reference is now made to FIGS. 2 and 6-8, in which a portion of the toaster 10 is illustrated with the housing 11 removed. Within the housing are a first end plate 28 at the front of the toaster 10 and an opposing second end plate 30 at the rear of the toaster 10. A generally vertical slot 44 is defined in the first end plate 28 and a generally vertical slot 46 is defined in the second end plate 30 (these vertical slots are discussed further below). First and second horizontal opposing slots 48, 50 are defined in the first end plate 28 (seen in FIGS. 6 and 7), and first and second horizontal opposing slots 60, 62 are defined in the second end plate 30 (seen in FIG. 8) (these horizontal slots are discussed further below).

Lifter bracket 26 is located within the housing 11 and is connected to the lifter arm 24, which in turn is connected to lifter knob 22 such that the lifter bracket 26 moves down when a user pushes lifter knob 22 down and lifter bracket 26 moves up when the toasting cycle is complete. An electromagnet holds the lifter bracket down during the toasting cycle and releases the lifter bracket to return to its up position. The lifter bracket 26 is biased toward its up position by spring 82. Only one lifter knob 22, one lifter arm 24, and one lifter bracket 26 is illustrated in FIGS. 2, 6 and 7, although the toaster 10 comprises two lifter knobs, two lifter arms, and two lifter brackets. Each lifter knob, lifter arm, and lifter bracket corresponds to two food item receiving slots. The lifter bracket 26 selectively moves up and down on lifter bracket guide rods 84. A portion of the lifter bracket 26 is omitted in FIGS. 6 and 7 to allow other components to be seen.

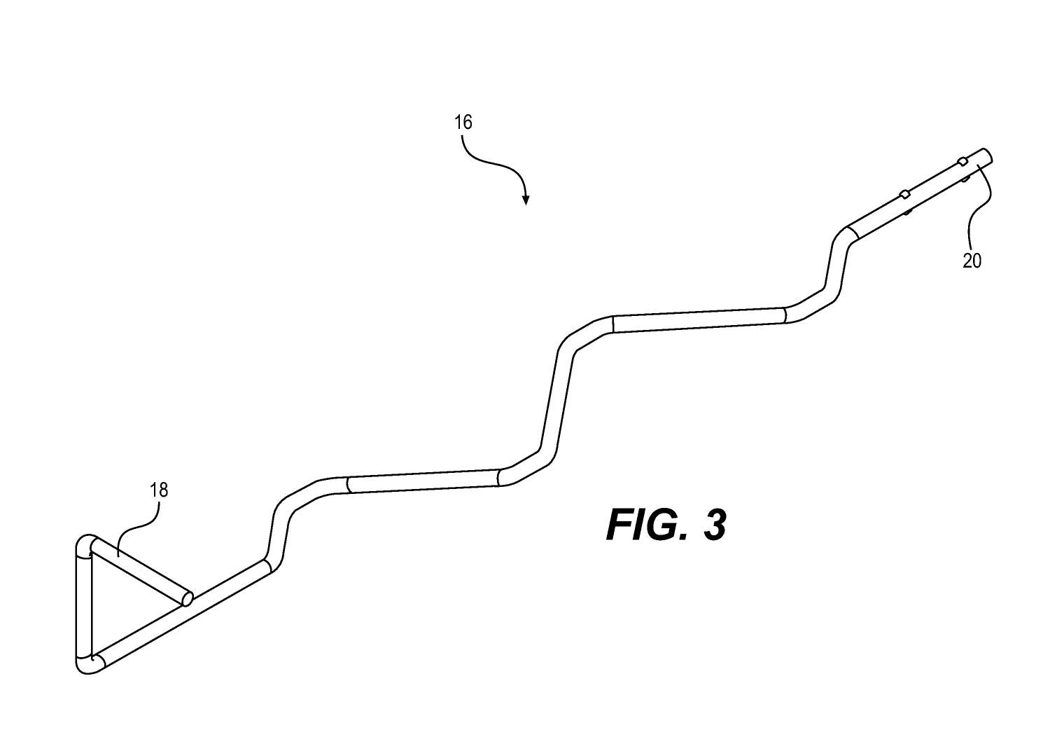

Referring now to FIG. 3, the toaster 10 further comprises at least one food item support 16 corresponding to and aligned with each food item receiving slot 15. The food item support 16 is selectively movable between an up position and a down position and is biased toward the up position by way of its connection to the lifter bracket 26, which is biased upward by spring 82. The food item support 16 comprises an elongated main body between a first end 18 and a second end 20. The main body is horizontally flat but, when viewed from above, has a zig-zag configuration that provides a shelf or ledge upon which a bread product sits. The food item support 16 moves up and down between two opposing grill wire assemblies (discussed further below). The first end 18 of the grill wire assembly projects through the generally vertical slot 44 in the first end plate 28 and is affixed to the lifter bracket 26 (as seen in FIG. 2), such that the food item support 16 moves up and down when the lifter bracket 26 moves up and down. The second end 20 of the grill wire assembly projects through the generally vertical slot 46 in the second end plate 30 (seen in FIG. 8).

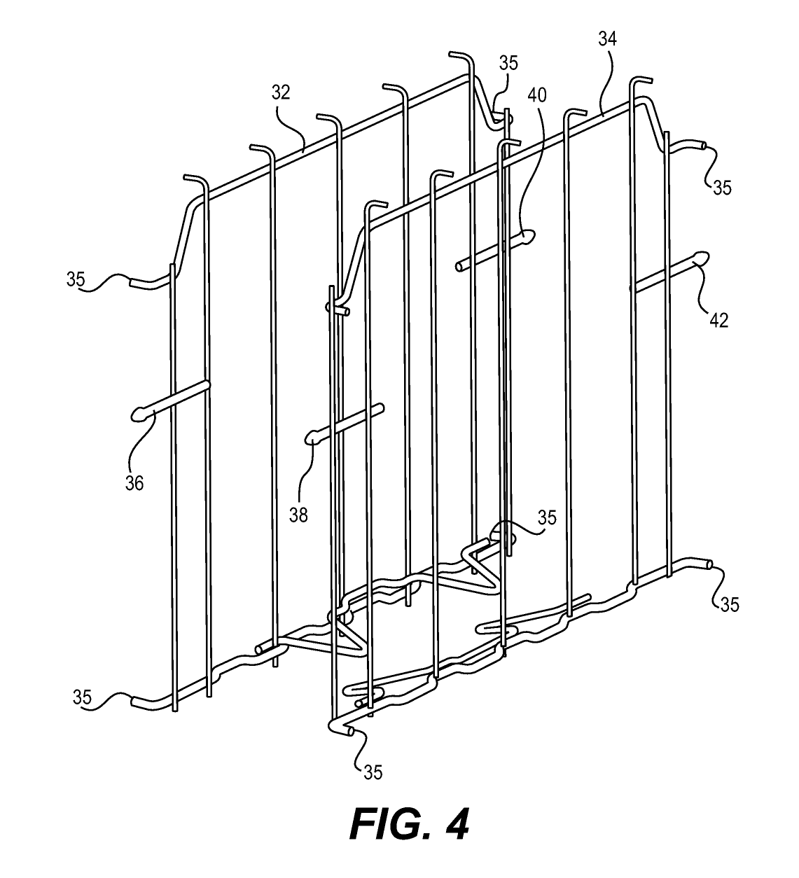

Referring now to FIG. 4, the toaster 10 further comprises a first grill wire assembly 32 and an opposing second grill wire assembly 34 corresponding to each food receiving slot 15. The first and second opposing grill wire assemblies 32, 34 are positioned between and generally perpendicular to the first and second end plates 28, 30. The first and second opposing grill wire assemblies 32, 34 move toward each other when the lifter knob 22, lifter arm 24, lifter bracket 26, and food item support 16 are moved down, as further described below, until the first and second opposing grill wire assemblies 32, 34 contact the bread product, thereby supporting the bread product during the toasting cycle. The toaster 10 further comprises a plurality of biasing springs 52 for biasing the first and second opposing grill wire assemblies 32, 34 toward each other while maintaining a generally parallel arrangement therebetween. The first and second opposing grill wire assemblies 32, 34 comprise a plurality of support arms 35. In the illustrated embodiment, there are top and bottom guide arms at the front and back of each grill wire assembly. Each guide arm projects through a corresponding horizontal slot defined in the first or second end plate 28, 30 to guide the movement of the grill wire assemblies and such that each one of the biasing springs 52 contacts a corresponding support arm 35 to provide the inward biasing force to the grill wire assemblies.

The first grill wire assembly 32 further comprises a first guide arm 36 and a second guide arm 40. The second grill wire assembly 34 further comprises a first guide arm 38 and a second guide arm 42. The first guide arm 36 of the first grill wire assembly 32 projects through the first horizontal slot 48 (the horizontal slot 48 is seen in FIGS. 6 and 7, but the first guide arm 36 cannot be seen) in the first end plate 28. The second guide arm 40 of the first grill wire assembly 32 projects through the first horizontal slot 60 (seen in FIG. 8) in the second end plate 30. The first guide arm 38 of the second grill wire assembly 34 projects through the second horizontal slot 50 (the horizontal slot 50 is seen in seen in FIGS. 6 and 7, but the first guide arm 38 cannot be seen) in the first end plate 28. The second guide arm 42 of the second grill wire assembly 34 projects through the second horizontal slot 62 (seen in FIG. 8) in the second end plate 30. As described in detail below, the guide arms of the grill wire assemblies cooperate with pivoting guide rods such that the grill wire assemblies are either held apart in an open position to allow a bread product to be inserted or allowed to move inward toward each other to contact and support the bread product.

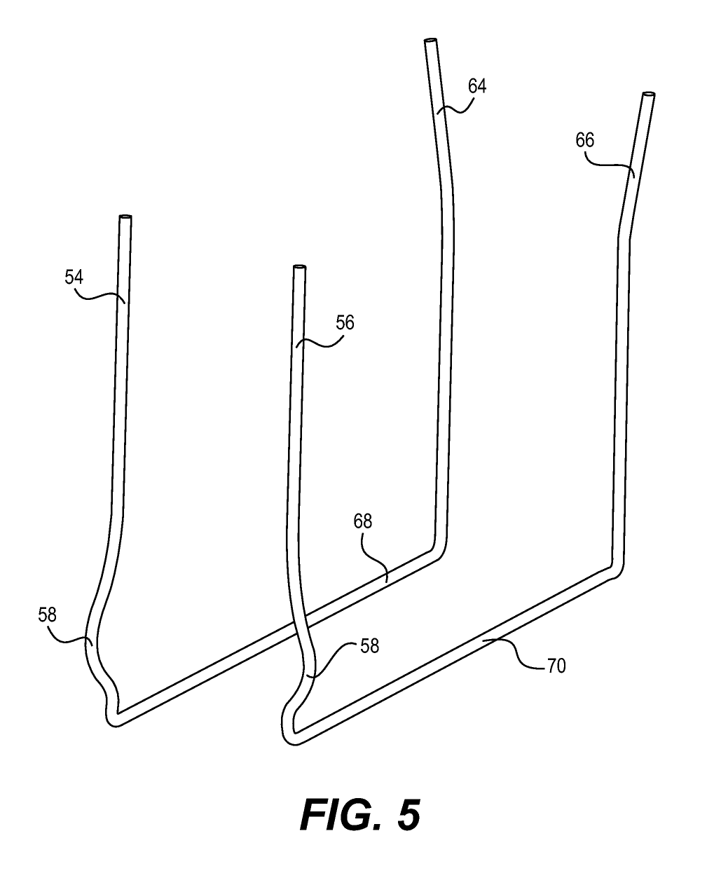

Referring now to FIG. 5, the toaster 10 comprises two opposing, generally U-shaped pivoting guide rod assemblies. Each guide rod assembly corresponds to and cooperates with one grill wire assembly. As seen in FIG. 5, one guide rod assembly comprises a first guide rod 54, a third guide rod 64, and a first connecting rod 68 connecting the first guide rod 54 and the third guide rod 64. The other guide rod assembly comprises a second guide rod 56, a fourth guide rod 66, and a second connecting rod 70 connecting the second guide rod 56 and the fourth guide rod 66. The first connecting rod 68 enables the first guide rod 54 and the third guide rod 64 to pivot in unison, while the second connecting rod 70 enables the second guide rod 56 and the fourth guide rod 66 to pivot in unison (as described further below). Each of the first and second guide rods 54, 56 comprise an outwardly arcuate lower portion 58 (discussed further below). The first guide rod 54, third guide rod 64, and first connecting rod 68 may comprise a unitary structure, as illustrated, or may alternatively comprise separate components that are joined together. Similarly, the second guide rod 56, fourth guide rod 66, and second connecting rod 70 may comprise a unitary structure, as illustrated, or may alternatively comprise separate components that are joined together.

Referring now to FIGS. 6-8, a plurality of connecting rod holes are defined in the first end plate 28 and the second end plate 30, and a bushing 80 is positioned in or adjacent to each of the connecting rod holes. The connecting rod holes comprise a first connecting rod hole 72 in the first end plate 28 and a first connecting rod hole 76 in the second end plate 30, such that the first connecting rod 68 projects through the first connecting rod holes, and associated bushings 80, of the first and second end plates 28, 30. This positions the first guide rod 54 on an opposite side of the first end plate 28 from the grill wire assemblies and positions the third guide rod 64 on an opposite side of the second end plate 30 from the grill wire assemblies. The connecting rod holes further comprise a second connecting rod hole 74 in the first end plate 28 and a second connecting rod hole 78 in the second end plate 30, such that the second connecting rod 68 projects through the second connecting rod holes, and associated bushings 80, of the first and second end plates 28, 30. This positions the second guide rod 56 on an opposite side of the first end plate 28 from the grill wire assemblies and positions the fourth guide rod 66 on an opposite side of the second end plate 30 from the grill wire assemblies. The bushings 80 support the first and second connecting rods 68, 70 in the desired positions and make it easier for the guide rod assemblies to pivot.

With reference to FIGS. 2 and 6-8, the first guide rod 54 cooperates with a lifter guide 27, which is part of the lifter bracket 26 (FIG. 2), and the first guide arm 36 of the first grill wire assembly 32 and the third guide rod 64 cooperates with the second guide arm 40 of the first grill wire assembly 32 to restrain inward movement of the first grill wire assembly 32 when the lifter bracket 26 is in the up position (FIG. 6) and to allow inward movement of the first grill wire assembly 32 when the lifter bracket 26 and associated lifter guide 27 are in the down position (FIG. 7). Similarly, the second guide rod 56 cooperates with the lifter guide 27 and the first guide arm 38 of the second grill wire assembly 34 and the fourth guide rod 66 cooperates with the second guide arm 42 of the second grill wire assembly 34 to restrain inward movement of the second grill wire assembly 34 when the lifter bracket 26 is in the up position (seen in FIG. 6) and to allow inward movement of the second grill wire assembly 34 when the lifter bracket 26 is in the down position (seen in FIG. 7). In short, the lifter guide 27 keeps the first guide rod 54 and second guide rod 56 in a parallel spaced relationship when lifter guide 27 is not in the down position. The first and second guide rod 54, 56 are held in this position so that the guide rods 54, 56 restrain the inward movement of the grill wire assemblies.

The inward biasing force against the first grill wire assembly 32 (discussed above) causes the first guide arm 36 of the first grill wire assembly 32 to push inward against the first pivoting guide rod 54 and causes the second guide arm 40 of the first grill wire assembly 32 to push inward against the third pivoting guide rod 64. Similarly, the inward biasing force against the second grill wire assembly 34 causes the first guide arm 38 of the second grill wire assembly 34 to push inward against the second pivoting guide rod 56 and causes the second guide arm 42 of the second grill wire assembly 34 to push inward against the fourth pivoting guide rod 66. However, when the lifter bracket 26, and thus the lifter guide 27, is not in the down position, the cooperation between the lifter guide 26 and the first pivoting guide rod 54 prevents the first pivoting guide rod 54 from being pivoted inward by the inward force from the first guide arm 36 of the first grill wire assembly 32. That is, the lifter guide 27 in the up position prevents the first pivoting guide rod 54 from pivoting inward despite the inward force being applied to it. Because the third pivoting guide rod 64 is connected to the first pivoting guide rod 54 (via the first connecting rod 68), the third pivoting guide rod 64 is also prevented from pivoting inward (seen in FIG. 8). Similarly, when the lifter guide 27 is not in the down position, the cooperation between the lifter guide 27 and the third pivoting guide rod 56 prevents the third pivoting guide rod 56 from being pivoted inward by the inward force from the first guide arm 38 of the second grill wire assembly 34. That is, the lifter guide 27 in the up position prevents the third pivoting guide rod 56 from pivoting inward despite the inward force being applied to it. Because the fourth pivoting guide rod 66 is connected to the third pivoting guide rod 56 (via the second connecting rod 70), the fourth pivoting guide rod 66 is also prevented from pivoting inward (seen in FIG. 8). In other words, the guide rods 54, 56 restrain the inner movement of the guide arms and grill wire assemblies.

When the lifter knob 22 is pushed down by a user, the lifter bracket 26 and associated lifter guide 27 correspondingly move downward from the up position of FIG. 6 to the down position of FIG. 7. As the lifter bracket 26 moves downward, the lifter guide 27 contacts different portions of the first and second pivoting guide rods 54, 56. In the down position, the lifter guide 27 arrives at the outwardly arcuate lower portions 58 of the first and second pivoting guide rods 54, 56. The outward arcuate portion increases the spacing between the first and second pivoting guide rods 54, 56 such that the lifter guide 27 does not restrain the inner biasing forces on the guides rods 54, 56 when the lifter guide is in contact with the outward arcuate portions 58. Accordingly, the asymmetry of the guide rods 54, 56 leads to the guide rods pivoting inwards in response to the inward biasing forces being applied to them (as described above) when lifter guide 27 is in contact with the outward arcuate portions 58 (FIG. 7). In other words, the guide rods 54, 56 due not restrain the inner movement of the guide arms or grill wire assemblies.

The lifter guide 27 may prevent the first and second pivoting guide rods 54, 56 from pivoting beyond a certain angle but does not restrain the inward pivoting movement from the vertical or parallel position. As there is a connection between the first pivoting guide rod 54 and the third pivoting guide rod 64, the third pivoting guide rod 64 also pivots inwardly. Similarly, because of the connection between the second pivoting guide rod 56 and the fourth pivoting guide rod 66, the fourth pivoting guide rod 66 also pivots inwardly. (The inwardly pivoted positions of the third and fourth pivoting guide rods 64, 66 are not illustrated.)

The inward pivoting of the first and third pivoting guide rods 54, 64 allows the first grill wire assembly 32 to move inward, and the inward pivoting of the third and fourth pivoting guide rods 56, 66 allows the second grill wire assembly 34 to move inward. Thus, the first and second grill wire assemblies 32, 34 move inward toward each other. The first and second grill wire assemblies 32, 34 will move inward until the first and second grill wire assemblies 32, 34 contact the inserted bread product (or reach the mechanical limit as presented by, e.g., opposing slots 48, 50), and the inwardly biasing force on the first and second grill wire assemblies 32, 34 will cause the first and second grill wire assemblies 32, 34 to hold and support the bread product during the toasting cycle. The inward position of the first and second grill wire assemblies is illustrated in FIG. 7 by the positions of the support arms 35, the first guide arm 36 of the first grill wire assembly 32, and the first guide arm 38 of the second grill wire assembly 34.

When the toasting cycle is complete, the lifter bracket 26 with lifter guide 27 begins to move upward such that lifter guide contacts the guide rods above the outward arcuate portions thereby causing the first and second pivoting guide rods 54, 56 to pivot outwardly (i.e., to return to a vertical, parallel position). The outward pivoting of the first and second pivoting guide rods 54, 56 in turn applies outward force, respectively, on the first guide arm 36 of the first grill wire assembly 32 and the first guide arm 38 of the second grill wire assembly 34, thereby causing outward movement of the first and second grill wire assemblies 32, 34.

The operation of toaster 10 and a method for toasting a food item using toaster 10 will now be described with reference to FIGS. 1-8. In operation, a food item (such as a bread product) is received through the food item receiving slot 15 defined in the top surface 14 of the housing 11 of the toaster 10 and onto the spring-loaded food item support 16 which is selectively movable between an up position and a down position and biased toward the up position. The food item support 16 is aligned with the food item receiving slot. In response to user action pushing down the lifter knob 22, the lifter bracket 26, which is selectively movable between an up position and a down position, is lowered to its down position, thereby moving the food item support 16 to its down position and beginning the toasting cycle. Typically, an electromagnet holds the lifter bracket 26 in its down position for the duration of the toasting cycle. In response to the lowering of the lifter bracket 26 to its down position, the first and second pivoting guide rods 54, 56 are allowed to inwardly pivot from the first position (seen in FIG. 6) to the second position (seen in FIG. 7). The inward pivoting of the first and second pivoting guide rods 54, 56 also results in the third and fourth pivoting guide rods 64, 66 being allowed to inwardly pivot from a first position (seen in FIG. 8) to a second position (not illustrated). In response to the first, second, third, and fourth pivoting guide rods 54, 56, 64, 66 inwardly pivoting from the first position to the second position, the first and second opposing grill wire assemblies 32, 34 are allowed to move inwardly toward each other, such that the first and second opposing grill wire assemblies 32, 34 hold and support the food item during the toasting cycle.

When the toasting cycle is complete, which may be determined using a thermostatic switch, a timing device, a combination thereof, or cancellation instruction from a user), the electromagnet is de-energized thereby releasing the lifter bracket 26 to return to its up position. As the lifter bracket 26 moves upward, the lifter bracket 26 forces the first and second pivoting guide rods 54, 56 to pivot outward and back to the first position (seen in FIG. 6). The third and fourth pivoting guide rods 64, 66 also pivot outward back to the first position (seen in FIG. 8) due to the mechanical link between the first and third pivoting guide rods 54, 64 and the second and fourth pivoting guide rods 56, 66. The outward pivoting of the first, second, third, and fourth pivoting guide rods 54, 56, 64, 66 pushes the first and second grill wire assemblies 32, 34 outward such that the first and second grill wire assemblies 32, 34 no longer hold the bread product and the bread product can be removed from the toaster 10.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A toaster comprising:
a housing having at least one food item receiving slot defined in a top surface;
at least one spring-loaded food item support, selectively movable between an up position and a down position and biased toward the up position, the at least one food item support being aligned with the at least one food item receiving slot;
first and second opposing end plates within the housing, at least the first end plate having first and second horizontal opposing slots defined therein;
first and second opposing grill wire assemblies positioned between and generally perpendicular to the first and second end plates, each of the first and second opposing grill wire assemblies comprising a first guide arm projecting through a corresponding one of the first and second horizontal slots in the first end plate;
one or more springs for biasing the first and second opposing grill wire assemblies toward each other;
a lifter bracket selectively movable between an up position and a down position to thereby selectively move the food item support between its up position and its down position; and
first and second pivoting guide rods, each guide rod cooperating with the first guide arm of a corresponding grill wire assembly, each of the first and second pivoting guide rods comprising an outwardly arcuate lower portion, each guide rod restrains inward movement of a corresponding one of the first and second grill wire assemblies when each guide rod is in a first position and such that each guide rod does not restrain inward movement of a corresponding one of the first and second grill wire assemblies when each guide rod is in a second position.

2. The toaster of claim 1, wherein the second position of each guide rod is pivoted inward from the first position of each guide rod.

3. The toaster of claim 2, wherein each guide rod further cooperates with the lifter bracket such that the lifter bracket restrains inward pivoting movement of the guide rods when the lifter bracket is in its up position and such that the lifter bracket does not restrain inward pivoting movement of the guide rods when the lifter bracket is in its down position.

4. The toaster of claim 1, wherein the second end plate has first and second horizontal opposing slots defined therein;
wherein each of the first and second opposing grill wire assemblies further comprise a second guide arm projecting through a corresponding one of the first and second horizontal slots in the second end plate;
wherein the toaster further comprises third and fourth pivoting guide rods, each of the third and fourth pivoting guide rods cooperating with the second guide arm of a corresponding grill wire assembly such that each of the third and fourth pivoting guide rods also restrains inward movement of a corresponding one of the first and second grill wire assemblies when each of the third and fourth guide pivoting rods is in a first position and such that each of the third and fourth pivoting guide rods does not restrain inward movement of a corresponding one of the first and second grill wire assemblies when each of the third and fourth pivoting guide rods is in a second position.

5. The toaster of claim 4, further comprising:
a first connecting rod connecting the first pivoting guide rod and the third pivoting guide rod such that the first pivoting guide rod and the third pivoting guide rod pivot in unison; and
a second connecting rod connecting the second pivoting guide rod and the fourth pivoting guide rod such that the second pivoting guide rod and the fourth pivoting guide rod pivot in unison.

6. The toaster of claim 5, wherein the first pivoting guide rod, the third pivoting guide rod, and the first connecting rod comprise a unitary, generally U-shaped structure; and
wherein the second pivoting guide rod, the fourth pivoting guide rod, and the second connecting rod comprise a unitary, generally U-shaped structure.

7. The toaster of claim 6, wherein first and second connecting rod holes are defined in the first end plate;
wherein first and second connecting rod holes are defined in the second end plate;
wherein the first connecting rod projects through the first connecting rod holes of the first and second end plates; and
wherein the second connecting rod projects through the second connecting rod holes of the first and second end plates.

8. The toaster of claim 7, further comprising a plurality of bushings, one each of the plurality of bushings positioned in or adjacent a respective one of the connecting rod holes such that plurality of bushings support the first and second connecting rods.

9. A method of toasting comprising:
receiving a food item through a food item receiving slot defined in a top surface of a housing of a toaster and onto a spring-loaded food item support that is selectively movable between an up position and a down position and biased toward the up position, the food item support being aligned with the food item receiving slot;
lowering, in response to user action, a lifter bracket that is selectively movable between an up position and a down position to its down position, thereby moving the food item support to its down position;
allowing, in response to the lowering of the lifter bracket to its down position, first and second pivoting guide rods to inwardly pivot from a first position to a second position, each of the first and second pivoting guide rods comprising an outwardly arcuate lower portion; and
allowing, in response to the first and second pivoting guide rods inwardly pivoting from the first position to the second position, first and second opposing grill wire assemblies to move inwardly toward each other, the first and second opposing grill wire assemblies being positioned within the housing between and generally perpendicular to first and second end plates, each of the first and second opposing grill wire assemblies comprising a first guide arm projecting through a corresponding one of first and second opposing horizontal slots in the first end plate, each of the first and second pivoting guide rods cooperating with the first guide arm of a corresponding grill wire assembly such that each guide rod restrains inward movement of a corresponding one of the first and second grill wire assemblies when each of the first and second pivoting guide rods is in its first position and such that each of the first and second pivoting guide rods does not restrain inward movement of a corresponding one of the first and second grill wire assemblies when each of the first and second pivoting guide rods is in its second position.

10. The method of claim 19, wherein each of the first and second pivoting guide rods further cooperates with the lifter bracket such that the lifter bracket restrains inward pivoting movement of the first and second pivoting guide rods when the lifter bracket is in its up position and such that the lifter bracket does not restrain inward pivoting movement of the first and second pivoting guide rods when the lifter bracket is in its down position.

11. The method of claim 9, further comprising:
allowing, in response to the lowering of the lifter bracket to its down position, third and fourth pivoting guide rods to inwardly pivot from a first position to a second position; and
wherein each of the first and second opposing grill wire assemblies further comprise a second guide arm projecting through a corresponding one of first and second opposing horizontal slots in the second end plate;
wherein each of the third and fourth pivoting guide rods cooperates with the second guide arm of a corresponding grill wire assembly such that each of the third and fourth pivoting guide rods also restrains inward movement of a corresponding one of the first and second grill wire assemblies when each of the third and fourth pivoting guide rods is in its first position and such that each of the third and fourth pivoting guide rods does not restrain inward movement of a corresponding one of the first and second grill wire assemblies when each of the third and fourth pivoting guide rods is in its second position.
